(19) United States
(12) Patent Application Publication
(10) Pub. No.: US 2011/0314028 A1
(43) Pub. Date: Dec. 22, 2011

(54) PRESENTING DISPLAY CHARACTERISTICS OF HIERARCHICAL DATA STRUCTURES

(75) Inventors: MOTI RADOMSKI, PETACH TIKVA (IL); ADI MILLER, TEL AVIV (IL); OMRI GUTMAN, KFAR SAVA (IL)

(73) Assignee: MICROSOFT CORPORATION, REDMOND, WA (US)

(21) Appl. No.: 12/818,320

(22) Filed: Jun. 18, 2010

(51) Int. Cl. G06F 17/30

(52) U.S. Cl. 707/748; 707/E17.044

(57) ABSTRACT

Embodiments of the present invention relate to systems, methods, and computer-storage media for providing a method of presenting display characteristics of data items organized in hierarchical data structures. In one embodiment, a hierarchical data structure includes a plurality of nodes. Each node of the hierarchical data structure has a node value. The weighted value of each particular node is determined based on the sum of the node value of each node and the node values of each descendant node of the particular node. Once display characteristics based on weighted values are associated with each node, the hierarchical data structure is presented. In particular, an indicator of at least a portion of the plurality of nodes is presented to include at least one display characteristic associated with the plurality of nodes within the hierarchical data structure.

### BACKGROUND

As individuals are increasingly expected to evaluate large amounts of data, it is important to find ways of assessing the value of data within the context of a large presentation of data, such as a hierarchical data structure. In particular, it is important to find ways of assessing the value of a node against values of other nodes across the hierarchical data structure. However, presentations of hierarchical data structures fail to illustrate the relative values of nodes across the entire hierarchical structure. As such, users reviewing a presentation of a hierarchical data structure have no way of evaluating the values of nodes and the values of descendants of nodes within the context of the presentation of the hierarchical data structure.

### SUMMARY

This Summary is provided to introduce a selection of concepts in a simplified form that are further described below in the Detailed Description. This Summary is not intended to identify essential features of the claimed subject matter, nor is it intended to be used as an aid in isolation to determine the scope of the claimed subject matter. Embodiments of the present invention provide methods for presenting display characteristics of data items organized in a hierarchical data structure. In particular, methods are provided for presenting display characteristics associated with a plurality of nodes within the hierarchical data structure, each node representing at least one data item.

Information associated with data items organized in a hierarchical data structure is conveyed through the use of display characteristics. Display characteristics are used to distinguish the appearance of data items organized in a hierarchical data structure from one another, so such items pertain to particular characteristics of interest. In particular, display characteristics may be presented in association with nodes within the hierarchical data structure in order to convey information about the nodes. For example, display characteristics may be presented to convey information based on content of nodes, importance of nodes, or both.

As described above, display characteristics may be used to distinguish the appearance of data presented in the hierarchical data structure. As such, display characteristics may include visual forms of distinguishing data within the hierarchical data structure. For example, display characteristics may include using different fonts to label nodes of the hierarchical data structure and convey differing characteristics associated with the nodes. Further, display characteristics may include different uses of colors, dimensionality, or sizes of nodes of the hierarchical data structure. As such, display characteristics may be used to distinguish information associated with nodes of the hierarchical data structure.

### BRIEF DESCRIPTION OF THE DRAWINGS

Illustrative embodiments of the present invention are described in detail below with reference to the attached drawing figures, wherein:

FIG. 1 is a block diagram illustrating an exemplary computing device suitable for use in connection with embodiments of the present invention;

FIG. 2 is a schematic diagram illustrating an exemplary hierarchical data structure, in accordance with an embodiment of the present invention;

FIG. 3A is a schematic diagram illustrating an exemplary hierarchical data structure comprising values of each node of the hierarchical data structure, in accordance with an embodiment of the present invention;

FIG. 3B is a schematic diagram illustrating an exemplary hierarchical data structure comprising summing of values of each node of the hierarchical data structure in FIG. 3A, in accordance with an embodiment of the present invention;

FIG. 3C is a schematic diagram illustrating an exemplary hierarchical data structure comprising summed values of each node of the hierarchical data structure in FIG. 3B, in accordance with an embodiment of the present invention;

FIG. 4A is a schematic diagram illustrating an exemplary hierarchical data structure comprising values of each node of the hierarchical data structure, in accordance with an embodiment of the present invention;

FIG. 4B is a schematic diagram illustrating an exemplary hierarchical data structure comprising summing of values of each node of the hierarchical data structure in FIG. 4A, in accordance with an embodiment of the present invention;

FIG. 4C is a schematic diagram illustrating an exemplary hierarchical data structure comprising summed values of each node of the hierarchical data structure in FIG. 4B, in accordance with an embodiment of the present invention;

FIG. 5A is a schematic diagram illustrating an exemplary hierarchical data structure displaying characteristics of a node of the hierarchical data structure based on summed weights of each descendant of each node, in accordance with an embodiment of the present invention;

FIG. 5B is a schematic diagram of a legend for interpreting the information presented in FIG. 5A, in accordance with an embodiment hereof;

FIG. 6A is a schematic diagram illustrating an exemplary hierarchical data structure presenting display characteristics of each node of the hierarchical data structure based on summed values for that node and each direct descendant of that node, in accordance with an embodiment of the present invention;

FIG. 6B is a schematic diagram of a legend for interpreting information conveyed by the display characteristics in FIG. 6A, in accordance with an embodiment hereof;

FIG. 7A is a schematic diagram illustrating an exemplary hierarchical data structure presenting display characteristics of each node of the hierarchical data structure based on content of each node, in accordance with an embodiment of the present invention;

FIG. 7B is a schematic diagram of a legend for interpreting information conveyed by the display characteristics in FIG. 7A, in accordance with an embodiment hereof;

FIG. 8A is a schematic diagram illustrating an exemplary hierarchical data structure presenting display characteristics of each node of the hierarchical data structure based on summed node value of each node and based on content of each node, in accordance with an embodiment of the present invention;

FIG. 8B is a schematic diagram of a legend for interpreting information conveyed by the display characteristics in FIG. 8A, in accordance with an embodiment hereof;

FIG. 9A is another schematic diagram illustrating an exemplary hierarchical data structure presenting display characteristics of each node of the hierarchical data structure based on summed node value of each node and based on content of each node, in accordance with an embodiment of the present invention;

FIG. 9B is a schematic diagram of a legend for interpreting information conveyed by the display characteristics in FIG. 9A, in accordance with an embodiment hereof;

FIG. 10 is a flow diagram illustrating a method of presenting display characteristics of data items organized in hierarchical data structures, in accordance with an embodiment of the present invention;

FIG. 11 is a flow diagram illustrating a method of presenting display characteristics of data items organized in hierarchical data structures, in accordance with an embodiment of the present invention; and

FIG. 12 is a flow diagram illustrating a method of presenting display characteristics of data items organized in hierarchical data structures, in accordance with an embodiment of the present invention.

### DETAILED DESCRIPTION

The subject matter of embodiments of the present invention is described with specificity herein to meet statutory requirements. Although the terms “step,” “block” and/or “module” etc. might be used herein to connote different components of methods or systems employed, the terms should not be interpreted as implying any particular order among or between various steps herein disclosed unless and except when the order of individual steps is explicitly described.

Embodiments of the present invention provide methods for presenting display characteristics of data items organized in a hierarchical data structure. In particular, methods are provided for presenting display characteristics associated with a plurality of nodes within the hierarchical data structure. In accordance with embodiments of the present invention, information associated with nodes of hierarchical data structures is assessed and associated with display characteristics. For example, information relating to content of nodes, values of nodes, and accumulated weighted values of nodes across a hierarchical data structure is assessed, identified, or both. Once information associated with nodes is determined, through assessment or identification, display characteristics are associated with the nodes based on the determined information. By presenting the nodes with display characteristics within the hierarchical data structure, information relating to the nodes may be visually understood and comprehended by an individual viewing the presentation of the hierarchical data structure.

Accordingly, in one embodiment, the present invention provides one or more computer-storage media having computer-executable instructions embodied thereon that, when executed, perform a method of presenting display characteristics of data items organized in hierarchical data structures. The method includes receiving a plurality of data items organized in a hierarchical data structure. The hierarchical data structure has a plurality of nodes. Each node of the plurality of nodes is associated with one of the plurality of data items and has a node value. Additionally, at least one particular node of the plurality of nodes includes one or more descendant nodes. The method further comprises determining a weighted value for each node of the plurality of nodes. The weighted value for the at least one particular node is based, at least in part, on a sum of the node value associated with the one or more descendant nodes of the at least one particular node.

The method further comprises receiving a plurality of display characteristics. Each display characteristic of the plurality of display characteristics is associated with one or more weighted values or a range of weighted values. Further, at least one of the plurality of display characteristics is associated with each node of the plurality of nodes based on the respective weighted value thereof. The method also includes presenting an indicator of at least a portion of the plurality of nodes. The presented portion is organized in accordance with the hierarchical data structure. The indicator of each presented node includes the associated at least one display characteristic.

In another embodiment, the present invention provides one or more computer-storage media having computer-executable instructions embodied thereon that, when executed, perform a method of presenting display characteristics of data items organized in hierarchical data structures. The method includes receiving a plurality of data items organized in a hierarchical data structure. The hierarchical data structure has a plurality of nodes. Each node of the plurality of nodes is associated with one of the plurality of data items and has a node value. Additionally, at least one particular node of the plurality of nodes includes one or more direct descendant nodes. The method further comprises determining a weighted value for each node of the plurality of nodes. The weighted value for the at least one particular node is based, at least in part, on a sum of the node value associated with the one or more direct descendant nodes of the at least one particular node.

The method further comprises receiving a plurality of display characteristics. Each display characteristic of the plurality of display characteristics is associated with one or more weighted values or a range of weighted values. Further, at least one of the plurality of display characteristics is associated with each node of the plurality of nodes based on the respective weighted value thereof. The method also includes presenting an indicator of at least a portion of the plurality of nodes. The presented portion is organized in accordance with the hierarchical data structure. The indicator of each presented node includes the associated at least one display characteristic.

A third embodiment of the present invention provides one or more computer-storage media having computer-executable instructions embodied thereon that, when executed, perform a method of presenting display characteristics of data items organized in hierarchical data structures. The method includes receiving a plurality of data items organized in a hierarchical data structure. The hierarchical data structure has a plurality of nodes. Each node of the plurality of nodes is associated with one of the plurality of data items and has a node value. Additionally, at least one particular node of the plurality of nodes includes one or more descendant nodes. The method further comprises determining a weighted value for each node of the plurality of nodes. The weighted value for the at least one particular node is based, at least in part, on a sum of the node value associated with the one or more descendant nodes of the at least one particular node.

The method further comprises receiving a first plurality of display characteristics. Each display characteristic of the first plurality of display characteristics is associated with one or more weighted values. Additionally, the method comprises receiving a second plurality of display characteristics. Each display characteristic of the second plurality of display characteristics is associated with content of the hierarchical data structure. Further, each display characteristic of the first plurality of display characteristics is associated with each node of the plurality of nodes. Additionally, each of the second plurality of display characteristics is associated with each node of the plurality of nodes. The method also includes presenting an indicator of at least a portion of the plurality of nodes. The presented portion is organized in accordance with the hierarchical data structure. The indicator of each presented node includes at least a first display characteristic from the first plurality of display characteristics and at least a second display characteristic from the second plurality of display characteristics.

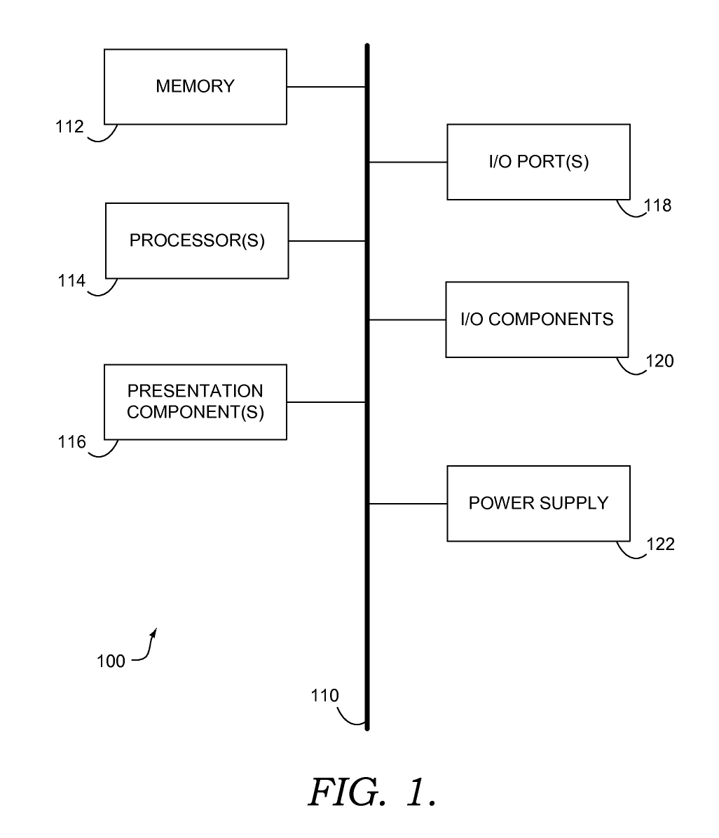

Having described an overview of embodiments of the present invention, an exemplary operating environment suitable for implementing embodiments hereof is now described. Referring to the drawings in general, and initially to FIG. 1 in particular, an exemplary computing device suitable for implementing embodiments of the present invention is shown and designated generally as computing device 100. The computing device 100 is but one example of a suitable computing environment and is not intended to suggest any limitation as to the scope of use or functionality of the invention. Neither should the computing device 100 be interpreted as having any dependency or requirement relating to any one or combination of illustrated modules, components, or both.

Embodiments may be practiced in a variety of system configurations, including handheld devices, consumer electronics, general-purpose computers, specialty computing devices, etc. Embodiments may also be practiced in distributed computing environments where tasks are performed by remote-processing devices that are linked through a communications network.

With continued reference to FIG. 1, the computing device 100 includes a bus 110 that directly or indirectly couples the following devices: a memory 112, one or more processors 114, one or more presentation modules 116, input/output (I/O) ports 118, I/O components 120, and an illustrative power supply 122. The bus 110 represents what may be one or more busses (such as an address bus, data bus, or combination thereof). Although the various blocks of FIG. 1 are shown with lines for the sake of clarity, in reality, these blocks represent logical, not necessarily actual, components. For example, one may consider a presentation component such as a display device to be an I/O component. Also, processors have memory. The inventors hereof recognize that such is the nature of the art, and reiterate that the diagram of FIG. 1 is merely illustrative of an exemplary computing device that can be used in connection with one or more embodiments of the present invention. Distinction is not made between such categories as “workstation,” “server,” “laptop,” “handheld device,” etc., as all are contemplated within the scope of FIG. 1 and reference to “computer” or “computing device.”

The computing device 100 typically includes a variety of computer-readable media. Computer-readable media can be any available media that can be accessed by the computing device 100 and includes both volatile and nonvolatile media, removable and nonremovable media implemented in any method or technology for storage of information such as computer-readable instructions, data structures, program modules, or other data. Computer-readable media includes, but is not limited to, Random Access Memory (RAM); Read Only Memory (ROM); Electronically Erasable Programmable Read Only Memory (EEPROM); flash memory or other memory technologies; CDROM, digital versatile disks (DVD) or other optical disk storage, magnetic cassettes, magnetic tape, magnetic disk storage or other magnetic storage devices, or any other medium that can be used to encode desired information and be accessed by computing device 100.

The memory 112 includes computer-storage media in the form of volatile and/or nonvolatile memory. The memory may be removable, nonremovable, or a combination thereof. Exemplary hardware devices include solid-state memory, hard drives, optical-disc drives, etc. The computing device 100 includes one or more processors that read data from various entities such as the memory 112 or the I/O components 120. The presentation component(s) 116 present data indications to a user or other device. Exemplary presentation components include a display device, speaker, printing component, vibrating component, and the like. The I/O ports 118 allow the computing device 100 to be logically coupled to other devices including the I/O modules 120, some of which may be built in. Illustrative components include a microphone, joystick, game pad, satellite dish, scanner, printer, wireless device, and the like.

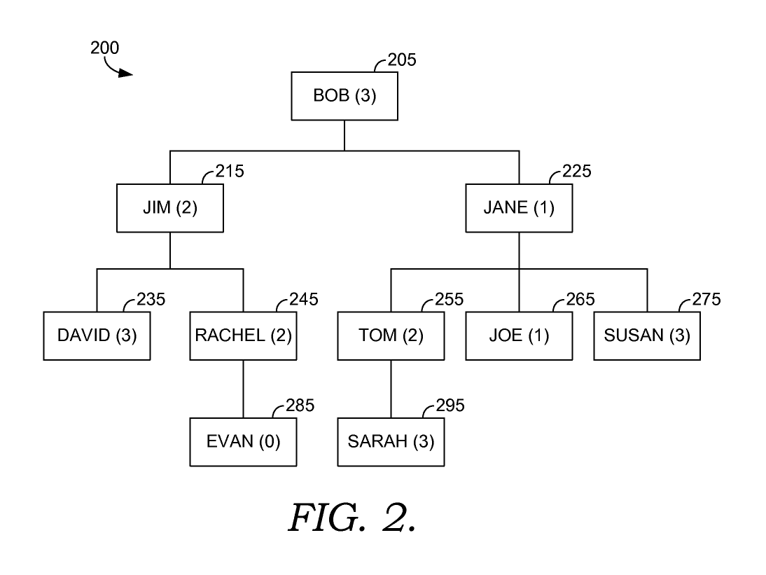

FIG. 2 is a schematic diagram illustrating an exemplary hierarchical data structure 200, in accordance with an embodiment of the present invention. As described herein, the hierarchical data structure 200 is a structure comprising a root and three distinct levels. Each of the three distinct levels are oriented with reference to the root level of the hierarchy. The root level of the hierarchy may be given a value of “0,” the level below may be given a level of “1,” and the value of levels may increase incrementally based on the distance of a level from the root level of the hierarchy. Further, the hierarchical data structure 200 includes a plurality of nodes. Of the plurality of nodes, at least one node is in a level distinct from the other plurality of nodes. Further, within the plurality of nodes, at least one node is a descendant of another node of the plurality of nodes. Further, a first node that is a descendant of a second node, and that is within one level of the second node, is considered a “direct descendant” of the second node.

The hierarchical data structure 200 is used to present data items having a hierarchical relationship with one another. In particular, hierarchical data structure 200 presents data related to a family tree. Each node of the hierarchical data structure 200 is associated with one member of the family tree. Further, each node of the family tree may have a value associated with it, such as the number of pets owned by each family member. Values represent comparative indicators of each node in the context of a particular characteristic of interest. For instance, if the particular characteristic of interest is the number of pets currently owned by the illustrated family members, the numerical value shown in association with each node indicates the number of pets owned by the family member associated with that node. As seen in FIG. 2, hierarchical data structure 200 illustrates the relationships between family members 205-295. In particular, each node of the hierarchical data structure 200 has a value indicating the number of pets owned by the family member associated with the node. Thus, in the hierarchical data structure 200 of FIG. 2, it is apparent that Bob owns 3 pets, Jim owns 2 pets, Jane owns 1 pet, David owns 3 pets, Rachel owns 2 pets, Tom owns 2 pets, Joe owns 1 pet, Susan owns 3 pets, Evan owns 0 pets, and Sarah owns 3 pets, respectively.

The family member 205, referred to as “Bob,” is at the root level of the hierarchical data structure 200. The structure 200 further comprises two family members 215 and 225, referred to as “Jim” and “Jane,” respectively, each at level 1 of the hierarchical data structure 200. Jim and Jane are both descendants of Bob. Further, since Jim and Jane are both descendants that are each one level below Bob, Jim and Jane are each direct descendants of Bob.

The hierarchical data structure 200 also comprises two further family members 235 and 245, referred to as “David” and “Rachel,” respectively. Both David and Rachel are at level 2 of the hierarchical data structure 200. Additionally, David and Rachel are each a descendants of Jim and Bob. Further, since David and Rachel are both descendants that are one level below Jim, David, and Rachel are each direct descendants of Jim. Similarly, hierarchical data structure 200 comprises family members 255, 265, and 275, referred to as “Tom,” “Joe,”, and “Susan,” respectively, each at level 2 of the hierarchical data structure. Tom, Joe, and Susan are each a descendant of Jane and Bob. Further, since Tom, Joe, and Susan are both descendants that are one level below Jane, Tom, Joe, and Susan are each direct descendants of Jane.

Further, hierarchical data structure 200 comprises a first family member 285, referred to herein as “Evan,” and a second family member 295, referred to herein as “Sarah.” Both Evan and Sarah are at level 3 of the hierarchical data structure. Additionally, Evan is a descendant of Rachel, Jim, and Bob, while Sarah is a descendant of Tom, Jane, and Bob. Further, Evan is a direct descendant of Rachel and Sarah is a direct descendant of Tom for reasons given above.

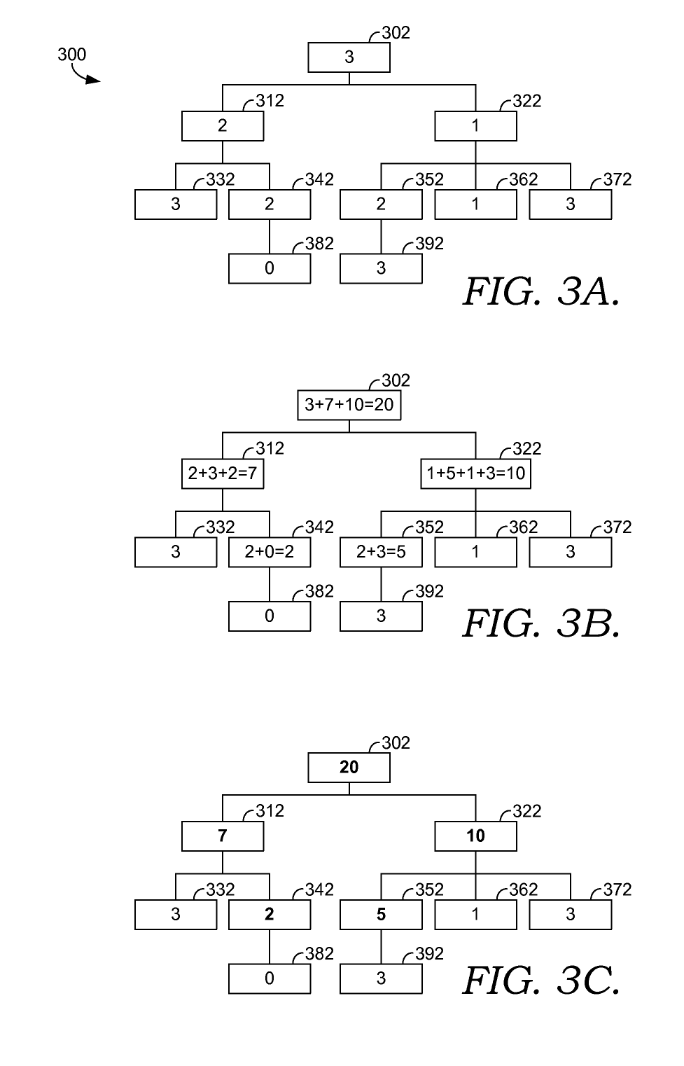

In embodiments, values associated with nodes of a hierarchical data structure may be weighted such that they are based on the sum of each original node value associated with a particular node and each descendant node thereof. An exemplary hierarchical data structure 300 having values weighted in this way is illustrated in FIGS. 3A-3C.

FIG. 3A includes a hierarchical data structure 300 wherein the values associated with each node of nodes 302-392 are representative of a comparative value with respect to a particular characteristic (e.g., number of pets) as it pertains only to each associated node. In particular, the node values of nodes 302-392 match those associated with family members in the hierarchical data structure 200 of FIG. 2. Further, FIGS. 3B and 3C illustrate how the node values for higher level nodes change if the value associated with each node of nodes 302-392 is weighted such that it represents a comparative value with respect to the same particular characteristic as it pertains not only to each associated node but also to all hierarchical descendant nodes of the associated node. Thus, the weighted value of node 352 in FIGS. 3B and 3C is calculated by summing the original node value of node 352 (“2”) with the original node value of its descendant node 392 (“3”). As such, the weighted value of node 352 is equal to the sum of 2+3, or “5.” Similarly, the weighted value of node 322 is calculated by summing the original node value of node 322 (“1”) with the original node vale of each of its descendant nodes 352 (“2”), 362 (“1”), 372 (“3”), and 392 (“3”). As such, the weighted value of node 322 is equal to the sum of 1+2+1+3+3, or “10.” In contrast to nodes 352 and 322, node 392 has no descendant nodes. As such, the weighted value of node 392 is equal to the original node value of node 392, which is “3.” In this way, a user viewing the distribution of weighted values across the hierarchical data structure 300 may view the weighted value of each node in the context of the entire hierarchical data structure 300.

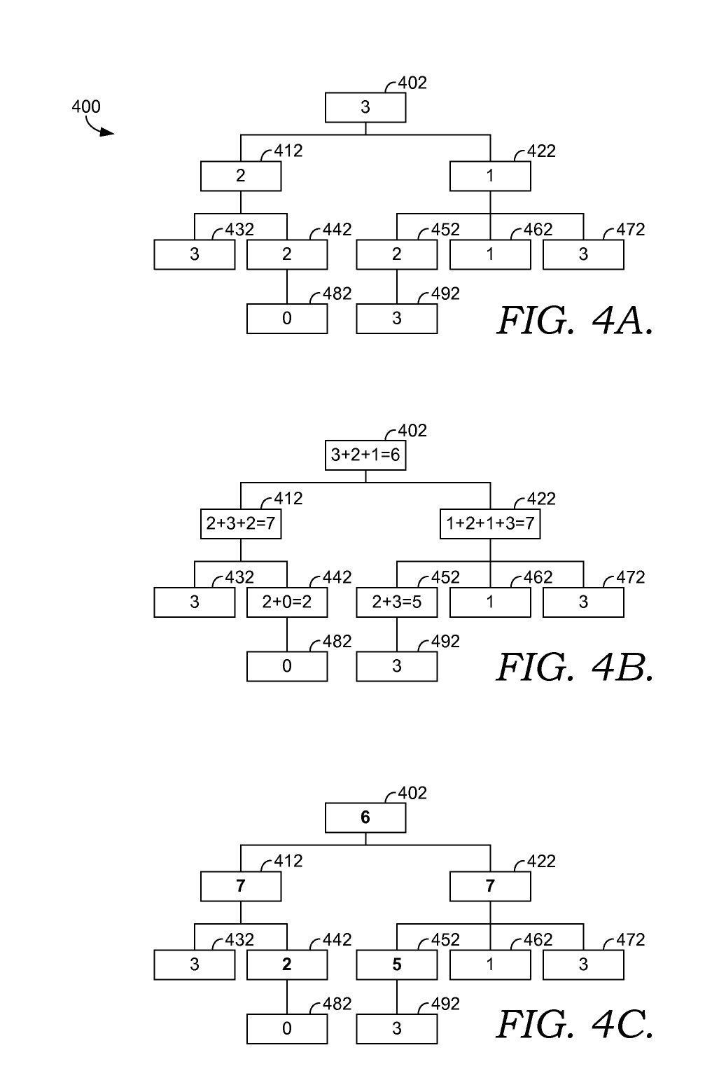

In embodiments, values associated with nodes of a hierarchical data structure may be weighted such that they are based on the sum of each original node value associated with a particular node and each direct descendant node thereof. An exemplary hierarchical data structure 400 having values weighted in this way is illustrated in FIGS. 4A-4C.

FIG. 4A includes a hierarchical data structure 400 wherein the values associated with each node of nodes 402-492 are representative of a comparative value with respect to a particular characteristic (e.g., number of pets) as it pertains only to each associated node. In particular, the node values of nodes 402-492 match those associated with family members in the hierarchical data structure 200 of FIG. 2. Further, FIGS. 4B and 4C illustrate how the node values for higher level nodes change if the values associated with each node 402-492 are weighted such that they represent comparative values with respect to the same particular characteristic as it pertains not only to each associated node but also to the hierarchical direct descendant nodes of each associated node. Thus, the weighted value of node 452 is equal to the sum of the original node value of 452 (“2”) and the node value of the direct descendant node of 452, 492 (“3”). As such, the weighted value of node 452 is the sum of 2+3, or “5.” Additionally, the weighted value of node 422 is calculated by summing the original node value of 422 (“1”) with the original node value of each of its direct descendant nodes 452 (“2”), 462 (“1”), and 472 (“3”). As such, the weighted value of node 422 is equal to the sum of 1+2+1+3, or “7.” In contrast to nodes 452 and 422, node 492 has no direct descendant nodes. As such, the weighted value of node 492 is equal to the original node value of node 492, which is “3.” In this way, a user viewing the distribution of weighted values across the hierarchical data structure 400 may view the weighted value of each node in the context of the entire hierarchical data structure 400.

It will be understood and appreciated by those of ordinary skill in the art that FIGS. 2, 3A-3C, and 4A-4C are merely exemplary and are not intended to limit embodiments of the present invention. Rather, values associated with nodes of a hierarchical data structure may be determined in any number of desired ways. For instance, values may be weighted based upon descendants only rather than node-plus-descendant nodes as shown in FIGS. 3B and 3C, or weighted based upon direct descendants only rather than node-plus-direct descendant nodes as shown in FIGS. 4B and 4C. Any and all such variations, and any combination thereof, are contemplated to be within the scope of embodiments of the present invention.

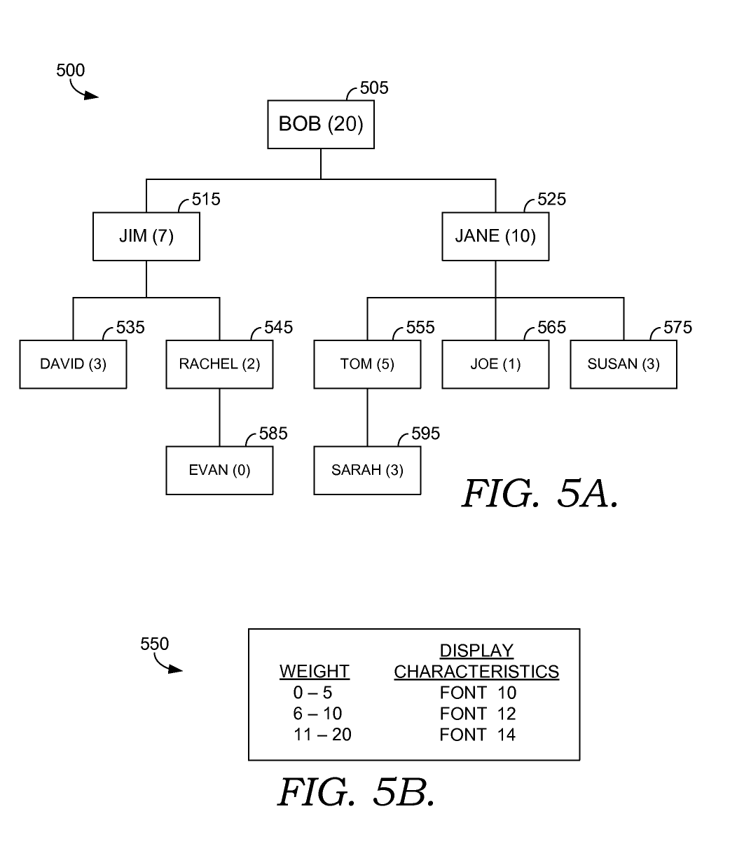

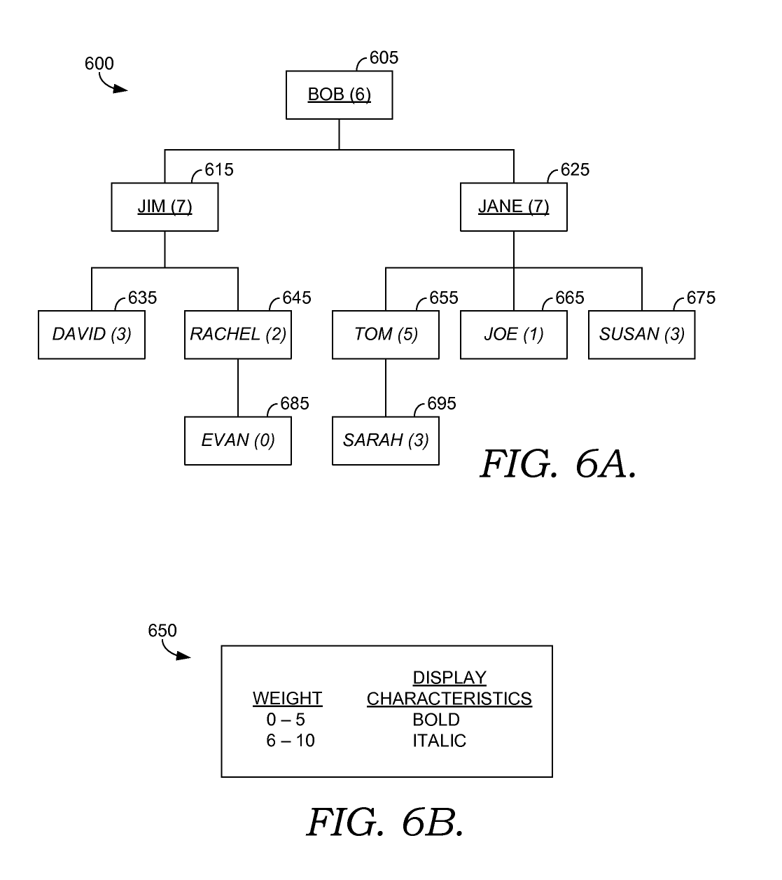

In embodiments, comparative weighted values may be conveyed through the use of display characteristics in addition to, or instead of, numerical indicators. Illustrations of display characteristics associated with values in a hierarchical data structure are shown in FIGS. 5 and 6 and are more fully described below.

Once values (original or weighted) have been determined for each node of a hierarchal data structure as it pertains to a particular characteristic of interest, display characteristics may be used to convey the information associated with the values. FIG. 5A is a schematic diagram illustrating an exemplary hierarchical data structure 500 presenting such display characteristics. In particular, each node of the illustrated hierarchical data structure 500 has an associated weighted value based on summed values for that nodes and each descendant of that node, in accordance with an embodiment of the present invention. Further, FIG. 5B provides a legend 550 to interpret the information conveyed by the display characteristics in FIG. 5A. In particular, FIG. 5B provides that weighted values of 0-5 are associated with a display characteristic of font 10 typeset; weighted values of 6-10 are associated with a display characteristic of font 12 typeset; and weighted values of 11-20 are associated with a display characteristic of font 14 typeset. Accordingly, nodes 535, 545, 555, 565, 575, 585, and 595 are presented in font 10 typeset, as each of these nodes has a weighted value between 0 and 5.Additionally, nodes 515 and 525 are presented in font 12 typeset, as each of these nodes has a weighted value between 6 and 10, and node 505 is presented in font 14 typeset, as this node has a weighted value between 11 and 20.

FIG. 6A is a schematic diagram illustrating an exemplary hierarchical data structure 600 presenting display characteristics of each node of the hierarchical data structure 600, wherein the values associated with each node are weighted based on summed values for that node and each direct descendant of that node, in accordance with an embodiment of the present invention. Further, FIG. 6B provides a legend 650 to interpret the information conveyed by the display characteristics in FIG. 6A. In particular, FIG. 6B provides that weighted values of 0-5 are associated with a display characteristic of bold font and weighted values of 6-10 are associated with a display characteristic of italicized font. Accordingly, nodes 635, 645, 655, 665, 675, 685, and 695 are presented in bold font, as each of these nodes has a weighted value between 0 and 5. Additionally, nodes 605, 615, and 625 are presented in italicized font, as each of these nodes has a weighted value between 6 and 10.

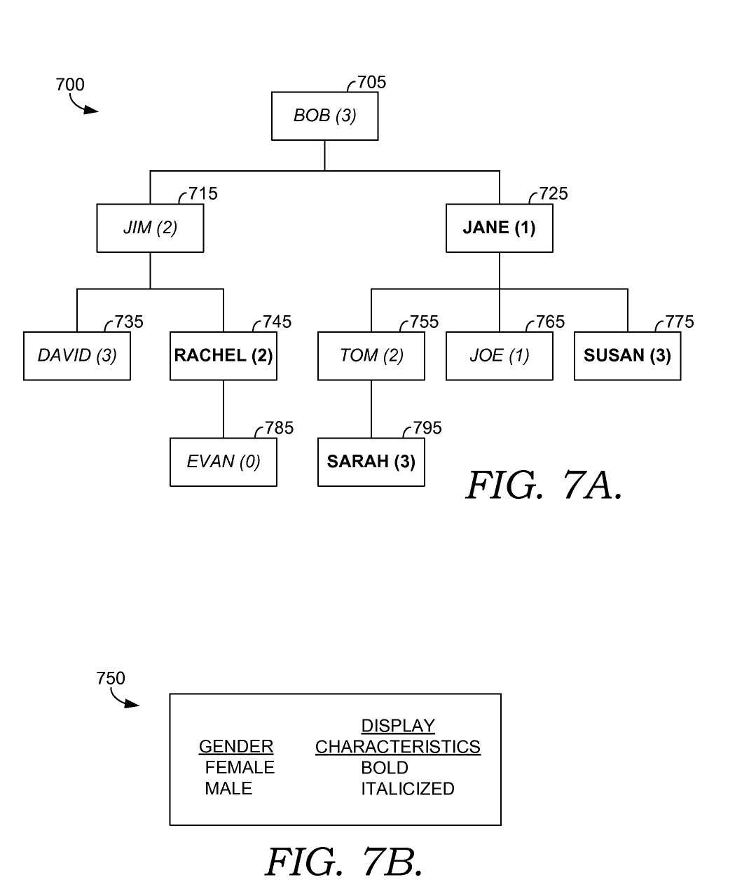

Instead of or in addition to conveying comparative node value through display characteristics, other information associated with the node content may be conveyed utilizing display characteristics, in accordance with embodiments hereof. For instance, FIG. 7A is a schematic diagram illustrating an exemplary hierarchical data structure 700 having display characteristics associated with the content of the associated node and a numerical indicator associated with the node value, in accordance with an embodiment of the present invention. In particular, each node of the hierarchical data structure 700 includes a display characteristic based on the gender of the family member associated with each node. For example, the family member having the name “Sarah” associated with node 795 is of the female gender, and the family member having the name “David” associated with node 735 is of the male gender.

FIG. 7B provides a legend 750 indicating that a node associated with a family member of the male gender is to have a display characteristic of bold typeset and a node associated with a family member of the female gender is to have a display characteristic of italicized typeset. Accordingly, nodes 725, 745, 775, and 795 of the hierarchical data structure 700 are presented in bold typeset, as each of these nodes is associated with a family member of the female gender. Further, nodes 705, 715, 735, 755, 765, and 785 of the hierarchical data structure 700 are presented in italicized typeset, as each of these nodes is associated with a family member of the male gender.

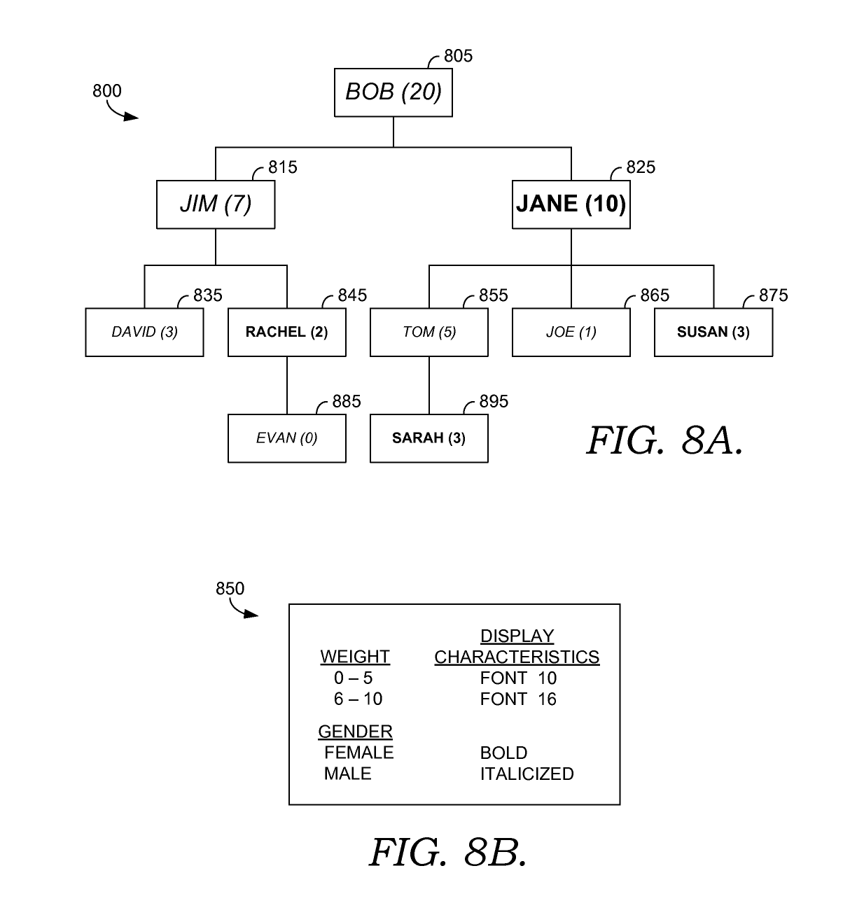

FIG. 8A is a schematic diagram illustrating an exemplary hierarchical data structure 800 having display characteristics associated with node values (weighted based on summed values of each node and each descendant of each node) and based on content of each node, in accordance with an embodiment of the present invention. In particular, each node of the hierarchical data structure 800 includes a display characteristic based on the gender of the family member associated with each node and another display characteristic based on the node's associated weighted value. For example, the family member having the name “Sarah” associated with node 895 is of the female gender, and the family member having the name “David” associated with node 835 is of the male gender. Accordingly, nodes 825, 845, 875, and 895 of the hierarchical data structure 800 are presented in bold typeset. Additionally, nodes 805, 815, 835, 855, 865, and 885 of the hierarchical data structure 800 are presented in italicized typeset.

Further, FIG. 8B provides a legend 850 to interpret the information conveyed by the display characteristics in FIG. 8A. In particular, FIG. 8B provides a legend 850 indicating that a node associated with a family member of the male gender is to have a display characteristic of bold typeset and a female gender is associated with a display characteristic of italicized typeset. Additionally, FIG. 8B also provides that weighted node values of 0-5 are associated with a display characteristic of font 10 typeset and weighted node values of 6-10 are associated with a display characteristic of font 16 typeset. As such, nodes 835, 845, 855, 865, 875, 885, and 895 are presented in font 10 typeset, as each of these nodes has a weighted value between 0 and 5. Additionally, nodes 805, 815, and 825 are presented in font 16 typeset, as each of these nodes has a weighted value between 6 and 10.

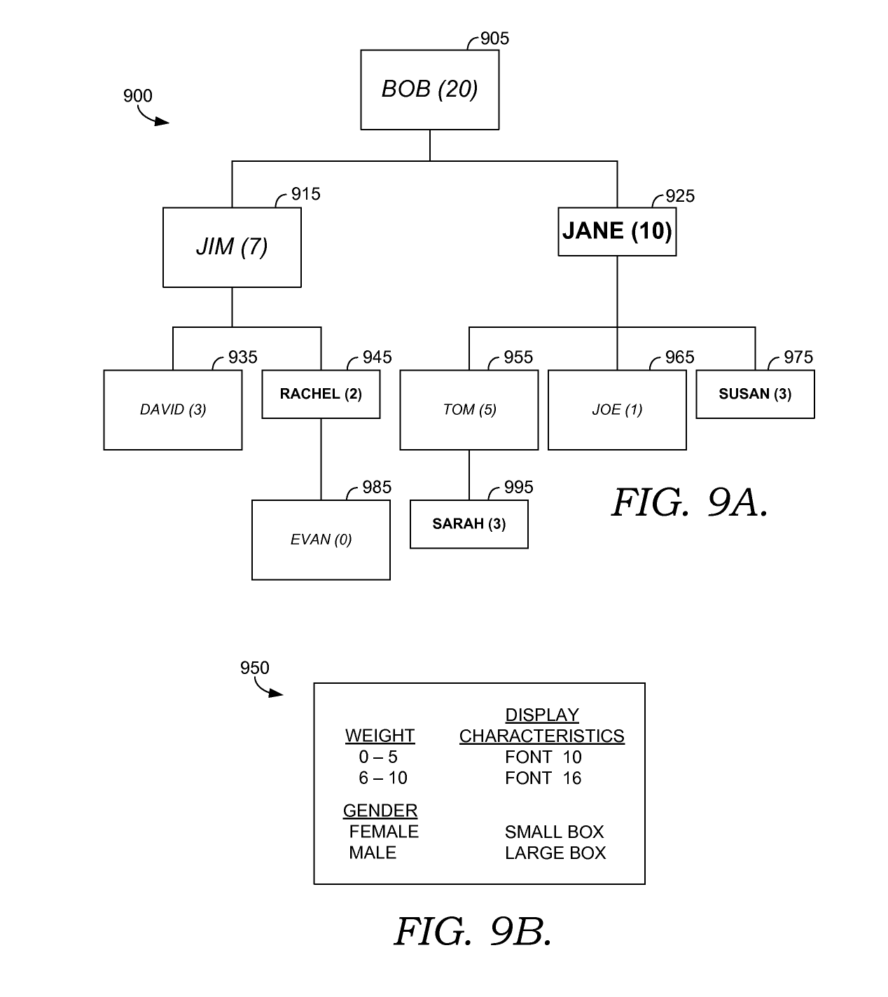

FIG. 9A is another schematic diagram illustrating an exemplary hierarchical data structure 900 having display characteristics associated with node values (weighted based on summed values of each node and each descendant of each node) and based on content of each node, in accordance with an embodiment of the present invention. In particular, each node of the hierarchical data structure 900 includes a display characteristic based on the gender of the family member associated with each node and another display characteristic based on the node's associated weighted value. Further, the gender-based display characteristic of each node is reflected in the size of each node. For example, the family member having the name “Sarah” associated with node 995 is of the female gender, and the family member having the name “David” associated with node 935 is of the male gender. Accordingly, nodes 925, 945, 975, and 995 of the hierarchical data structure 800 are presented in small-sized nodes. Additionally, nodes 905, 915, 935, 955, 965, and 985 of the hierarchical data structure 800 are presented in large-sized nodes.

Further, FIG. 9B provides a legend 950 to interpret the information conveyed by the display characteristics in FIG. 9A. In particular, FIG. 9B provides a legend 950 indicating that a node associated with a family member of the male gender is to have a display characteristic of a large-sized node and a female gender is associated with a display characteristic of a small-sized node. Additionally, FIG. 9B also provides that weighted node values of 0-5 are associated with a display characteristic of font 10 typeset and weighted node values of 6-10 are associated with a display characteristic of font 16 typeset. As such, nodes 935, 945, 955, 965, 975, 985, and 995 are presented in font 10 typeset, as each of these nodes has a weighted value between 0 and 5. Additionally, nodes 905, 915, and 925 are presented in font 16 typeset, as each of these nodes has a weighted value between 6 and 10.

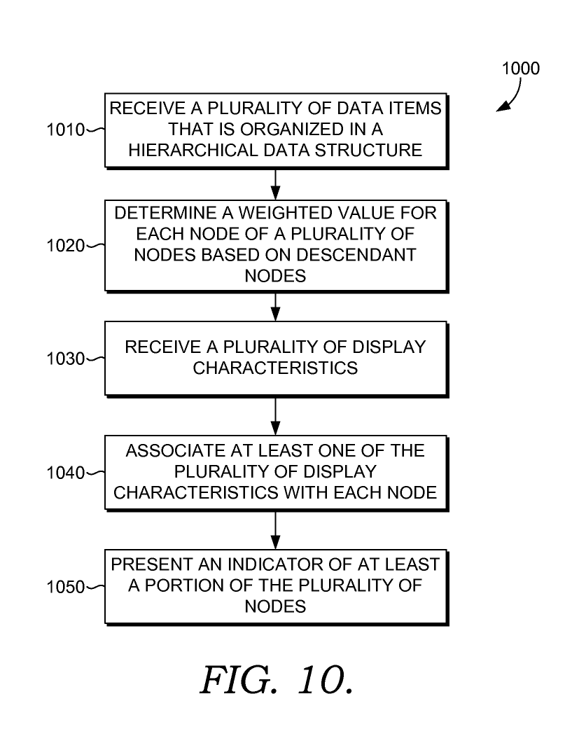

Turning now to FIG. 10, a flow diagram 1000 is shown illustrating a method of presenting display characteristics of data items organized in hierarchical data structures, in accordance with an embodiment of the present invention. At block 1010, a plurality of data items is received. In particular, the plurality of data items is organized in a hierarchical data structure. The hierarchical data structure has a plurality of nodes. Further, each node of the plurality of nodes is associated with one of the plurality of data items and has a node value. Additionally, at least one particular node of the plurality of nodes includes one or more descendant nodes. At block 1020, a weighted value is determined for each node of the plurality of nodes. The weighted value for the at least one particular node is based, at least in part, on a sum of the node value associated with the one or more descendant nodes of the at least one particular node. For example, the weighted value for the at least one particular node may comprise the sum of the node value of the at least one particular node and the node values associated with each descendant node of the at least one particular node. Alternatively, the weighted value for the at least one particular node may comprise the sum of the node values associated with each descendant node of the at least one particular node. When a node lacks a descendant node, the weighted value for the node without a descendant node may comprise the node value of the node. In further embodiments, each node value may be equal to the weighted value of each node of the hierarchical data structure.

At block 1030, a plurality of display characteristics is received. Each display characteristic of the plurality of display characteristics may be associated with one or more weighted values. For example, a display characteristic may be associated with a range of weighted values. At block 1040, at least one of the plurality of display characteristics is associated with each node of the plurality of nodes. In particular, each associated display characteristic is based on the respective weighted value thereof. At block 1050, an indicator of at least a portion of the plurality of nodes is presented. The presented portion is organized in accordance with the hierarchical data structure. The indicator of each presented node includes the associated at least one display characteristic. In embodiments, presenting an indicator of at least a portion of the plurality of nodes may comprise conveying information relating to the weighted value of each node in relation to weighted values of each node across the hierarchical data structure.

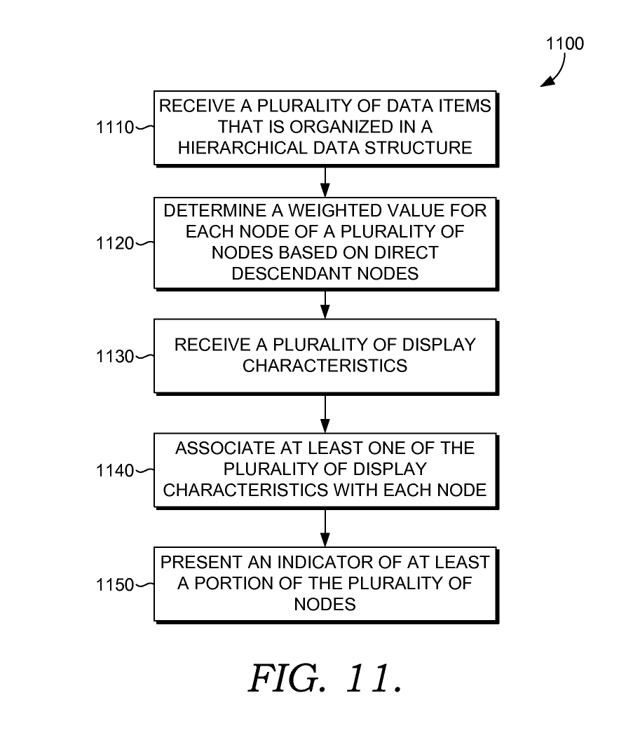

FIG. 11 is a flow diagram 1100 shown illustrating a method of presenting display characteristics of data items organized in hierarchical data structures, in accordance with an embodiment of the present invention. At block 1110, a plurality of data items is received. In particular, the plurality of data items is organized in a hierarchical data structure. The hierarchical data structure has a plurality of nodes. Further, each node of the plurality of nodes is associated with one of the plurality of data items and has a node value. Additionally, at least one particular node of the plurality of nodes includes one or more direct descendant nodes. At block 1120, a weighted value is determined for each node of the plurality of nodes. The weighted value for the at least one particular node is based, at least in part, on a sum of the node value associated with the one or more direct descendant nodes of the at least one particular node. For example, the weighted value for the at least one particular node may comprise the sum of the node value of the at least one particular node and the node values associated with each direct descendant node of the at least one particular node. Alternatively, the weighted value for the at least one particular node may comprise the sum of the node values associated with each direct descendant node of the at least one particular node. When a node lacks a direct descendant node, the weighted value for the node without a direct descendant node may comprise the node value of the node. In further embodiments, each node value may be equal to the weighted value of each node of the hierarchical data structure.

At block 1130, a plurality of display characteristics is received. Each display characteristic of the plurality of display characteristics may be associated with one or more weighted values. For example, a display characteristic may be associated with a range of weighted values. At block 1140, at least one of the plurality of display characteristics is associated with each node of the plurality of nodes. In particular, each associated display characteristic is based on the respective weighted value thereof. At block 1150, an indicator of at least a portion of the plurality of nodes is presented. The presented portion is organized in accordance with the hierarchical data structure. The indicator of each presented node includes the associated at least one display characteristic. In embodiments, presenting an indicator of at least a portion of the plurality of nodes may comprise conveying information relating to the weighted value of each node in relation to weighted values of each node across the hierarchical data structure.

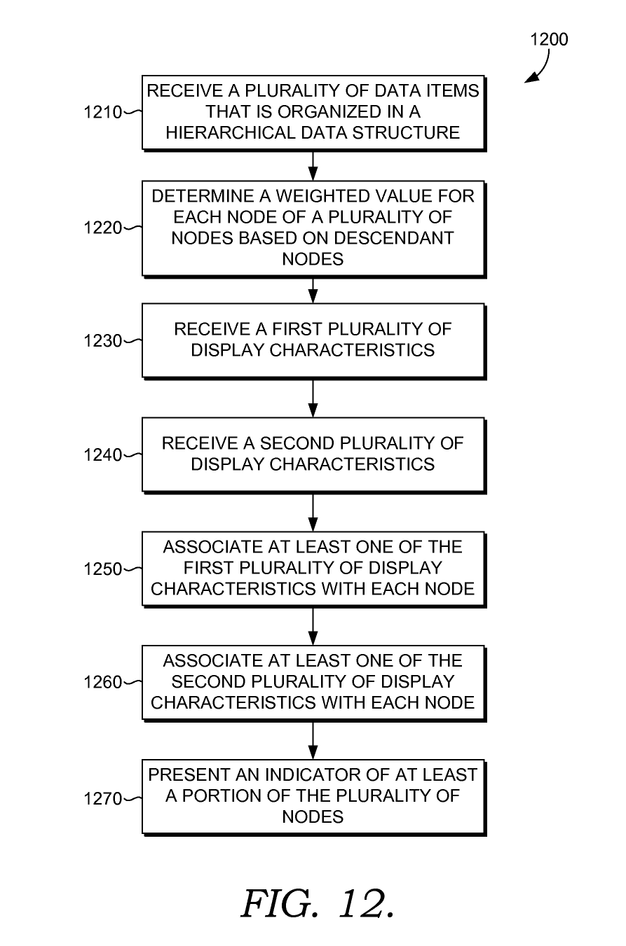

FIG. 12 is a flow diagram 1200 is shown illustrating a method of presenting display characteristics of data items organized in hierarchical data structures, in accordance with an embodiment of the present invention. At block 1210, a plurality of data items is received. In particular, the plurality of data items is organized in a hierarchical data structure. The hierarchical data structure has a plurality of nodes. Further, each node of the plurality of nodes is associated with one of the plurality of data items and has a node value. Additionally, at least one particular node of the plurality of nodes includes one or more descendant nodes. At block 1220, a weighted value is determined for each node of the plurality of nodes. The weighted value for the at least one particular node is based, at least in part, on a sum of the node value associated with the one or more descendant nodes of the at least one particular node. In embodiments, a weighted value for a node without a descendant node may comprise the node value of the node. In further embodiments, the weighted value of each node of the hierarchical structure may match the node value of each node of the hierarchical structure.

At block 1230, a first plurality of display characteristics is received. Each display characteristic of the first plurality of display characteristics may be associated with one or more weighted values. For example, a display characteristic may be associated with a range of weighted values. At block 1240, a second plurality of display characteristics is received. Each display characteristic of the second plurality of display characteristics may be associated with content of the hierarchical data structure. In particular, each display characteristic of the second plurality of display characteristics may be associated with content across the plurality of nodes within the hierarchical data structure.

In embodiments, the first plurality of display characteristics may be related to the second plurality of display characteristics. For example, the first plurality of display characteristics may be inversely proportional to the second plurality of display characteristics. Alternatively, the first plurality of display characteristics may be proportional to the second plurality of display characteristics. Further, each display characteristic associated with a node may convey information of the node within the context of the entire hierarchical data structure.

At block 1250, at least one of the first plurality of display characteristics is associated with each node of the plurality of nodes. In particular, each associated display characteristic of the first plurality of display characteristics is based on the respective weighted value thereof. 1260, at least one of the second plurality of display characteristics is associated with each node of the plurality of nodes. In particular, each associated display characteristic of the second plurality of display characteristics is based on the content thereof. At block 1270, an indicator of at least a portion of the plurality of nodes is presented. The presented portion is organized in accordance with the hierarchical data structure. The indicator of each presented node includes the associated at least a first display characteristic from the first plurality of display characteristics and at least a second display characteristic from the second plurality of display characteristics.

Many different arrangements of the various components depicted, as well as components not shown, are possible without departing from the spirit and scope of the present invention. Embodiments of the present invention have been described with the intent to be illustrative rather than restrictive. Alternative embodiments will become apparent to those skilled in the art that do not depart from its scope. A skilled artisan may develop alternative means of implementing the aforementioned improvements without departing from the scope of the present invention.

It will be understood that certain features and subcombinations are of utility and may be employed without reference to other features and subcombinations and are contemplated within the scope of the claims. Not all steps listed in the various figures need be carried out in the specific order described.

1. One or more computer-storage media having computer-executable instructions embodied thereon that, when executed, perform a method of presenting display characteristics of data items organized in hierarchical data structures, the method comprising:
receiving a plurality of data items organized in a hierarchical data structure, the hierarchical data structure having a plurality of nodes, wherein each node of the plurality of nodes is associated with one of the plurality of data items, wherein each node of the plurality of nodes has a node value, and wherein at least one particular node of the plurality of nodes includes one or more descendant nodes;
determining a weighted value for each node of the plurality of nodes, wherein the weighted value for the at least one particular node is based, at least in part, on a sum of the node value associated with the one or more descendant nodes of the at least one particular node;
receiving a plurality of display characteristics, each display characteristic being associated with one or more weighted values;
associating at least one of the plurality of display characteristics with each node of the plurality of nodes based on the respective weighted value thereof; and
presenting an indicator of at least a portion of the plurality of nodes, the presented portion being organized in accordance with the hierarchical data structure, wherein the indicator of each presented node includes the associated at least one display characteristic.

2. The one or more computer-storage media of claim 1, wherein the weighted value for the at least one particular node comprises the sum of the node value of the at least one particular node and the node values associated with each descendant node of the at least one particular node.

3. The one or more computer-storage media of claim 1, wherein the weighted value for the at least one particular node comprises the sum of the node values associated with each descendant node of the at least one particular node.

4. The one or more computer-storage media of claim 1, wherein each node value is equal to the weighted value of each node of the hierarchical data structure.

5. The one or more computer-storage media of claim 1, wherein presenting an indicator of at least a portion of the plurality of nodes comprises conveying information relating to the weighted value of each node in relation to weighted values of each node across the hierarchical data structure.

6. The one or more computer-storage media of claim 1, wherein the weighted value for a node without a descendant node comprises the node value of the node.

7. One or more computer-storage media having computer-executable instructions embodied thereon that, when executed, perform a method of presenting display characteristics of data items organized in hierarchical data structures, the method comprising:
receiving a plurality of data items organized in a hierarchical data structure, the hierarchical data structure having a plurality of nodes, wherein each node of the plurality of nodes is associated with one of the plurality of data items, wherein each node of the plurality of nodes has a node value, and wherein at least one particular node of the plurality of nodes includes one or more descendant nodes;
determining a weighted value for each node of the plurality of nodes, wherein the weighted value for the at least one particular node is based, at least in part, on a sum of the node value associated with the one or more direct descendant nodes of the at least one particular node;
receiving a plurality of display characteristics, each display characteristic being associated with one or more weighted values;
associating at least one of the plurality of display characteristics with each node of the plurality of nodes based on the respective weighted value thereof; and
presenting an indicator of at least a portion of the plurality of nodes, the presented portion being organized in accordance with the hierarchical data structure, wherein the indicator of each presented node includes the associated at least one display characteristic.

8. The one or more computer-storage media of claim 7, wherein the weighted value for the at least one particular node comprises the sum of the node value of the at least one particular node and the node values associated with each direct descendant node of the at least one particular node.

9. The one or more computer-storage media of claim 7, wherein the weighted value for the a least one particular node comprises the sum of the node values associated with each direct descendant node of the at least one particular node.

10. The one or more computer-storage media of claim 7, wherein the node value is equal to the weighted value of each node of the hierarchical data structure.

11. The one or more computer-storage media of claim 7, wherein the weighted value for a node without a direct descendant node comprises the node value of the node.

12. The one or more computer-storage media of claim 7, presenting an indicator of at least a portion of the plurality of nodes comprises conveying information relating to the weighted value of each node in relation to weighted values of each node across the hierarchical data structure.

13. One or more computer-storage media having computer-executable instructions embodied thereon that, when executed, perform a method of presenting display characteristics of data organized in hierarchical data structures, the method comprising:
receiving a plurality of data items organized in a hierarchical data structure, the hierarchical data structure having a plurality of nodes, wherein each node of the plurality of nodes is associated with one of the plurality of data items, wherein each node of the plurality of nodes has a node value, and wherein at least one particular node of the plurality of nodes includes one or more descendant nodes;
determining a weighted value for each node of the plurality of nodes, wherein the weighted value for the at least one particular node is based, at least in part, on a sum of the node value associated with the one or more descendant nodes of the at least one particular node;
receiving a first plurality of display characteristics, each display characteristic of the first plurality of display characteristics being associated with one or more weighted values;
receiving a second plurality of display characteristics, each display characteristic of the second plurality of display characteristics being associated with content of the hierarchical data structure;
associating at least one of the first plurality of display characteristics with each node of the plurality of nodes based on the respective weighted value thereof;
associating at least one of the second plurality of display characteristics with each node of the plurality of nodes based on the content thereof; and
presenting an indicator of at least a portion of the plurality of nodes, the presented portion being organized in accordance with the hierarchical data structure, wherein the indicator of each presented node includes the associated at least a first display characteristic from the first plurality of display characteristics and at least a second display characteristic from the second plurality of display characteristics.

14. The one or more computer-storage media of claim 13, wherein the first plurality of display characteristics are related to the second plurality of display characteristics.

15. The one or more computer-storage media of claim 14, wherein the first plurality of display characteristics are inversely proportional to the second plurality of display characteristics.

16. The one or more computer-storage media of claim 14, wherein the first plurality of display characteristics are proportional to the second plurality of display characteristics.

17. The one or more computer-storage media of claim 13, wherein each display characteristic associated with a node conveys information of the node within the context of the entire hierarchical data structure.

18. The one or more computer-storage media of claim 13, wherein the weighted value for a node without a descendant node comprises the node value of the node.

19. The one or more computer-storage media of claim 13, wherein each display characteristic of the second plurality of display characteristics is associated with content across the plurality of nodes within the hierarchical data structure.

20. The one or more computer-storage media of claim 13, wherein the weighted value of each node of the hierarchical structure matches the node value of each node of the hierarchical structure.
